(19) United States
(12) Patent Application Publication
(10) Pub. No.: US 2010/0315987 A1
(43) Pub. Date: Dec. 16, 2010

(54) Method and Apparatus for Improving MCCH Monitoring Mechanism

(76) Inventor: Richard Lee-Chee Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/815,421

(22) Filed: Jun. 15, 2010

Related U.S. Application Data
(60) Provisional application No. 61/187,279, filed on Jun. 16, 2009.

(51) Int. Cl. H04H 20/71

(52) U.S. Cl. 370/312

(57) ABSTRACT

A method for improving MCCH monitoring mechanism in a network terminal of a wireless communication system is disclosed. The method includes steps of delivering an MBMS service announcement to a UE of the wireless communication system, which contains a list of MBMS services to be broadcast in the network and service related information, one of the service related information indicating which MBSFN area(s) an MBMS service is broadcasted in; transmitting session start information of the said MBMS service on the MCCH associated with the indicated MBSFN area; and starting broadcasting the said MBMS service in the indicated MBSFN area(s).

### CROSS REFERENCE TO RELATED APPLICATIONS

This application claims the benefit of U.S. Provisional Application No. 61/187,279, filed on Jun. 16, 2009 and entitled “Method and apparatus for MCCH Acquisition in a wireless communication system”, the contents of which are incorporated herein by reference.

### BACKGROUND OF THE INVENTION

1. Field of the Invention

The present invention relates to a method and apparatus for improving MCCH monitoring mechanism, and more particularly, to a method and apparatus for improving MCCH monitoring mechanism in a network terminal of a wireless communication system, so as to save UE power consumption.

2. Description of the Prior Art

To enhance multimedia performance of the 3G mobile telecommunications system, the 3rd Generation Partnership Project (3GPP) introduces a Multimedia Broadcast Multicast Service (MBMS), which is a point-to-multipoint bearer service established on an existing network architecture of the Universal Mobile Telecommunications System (UMTS). MBMS allows a single source terminal to simultaneously transmit data to multiple user equipments (UEs) via Internet Protocol (IP) packets.

However, as the multimedia performance of mobile devices advances, consumers are more interested to have multimedia or mobile TV services via the mobile devices. In order to meet such requirement, the 3GPP introduces an enhanced MBMS (eMBMS) in a specification of long term evolution (LTE) Release-9, to support high quality streaming multimedia and real-time MBMS services.

According to 3GPP specification TS23.246, a service announcement is used to distribute to users information about the service, parameters required for service activation (e.g. IP multicast address(es)) and possibly other service related parameters (e.g. service start time). The service announcement may be sent some time before the service is due to start. This time period could be hours, days or even weeks depending on different service types.

In addition, eMBMS introduces a single frequency network (SFN) operation for MBMS transmission, i.e. MBMS Single Frequency Network (MBSFN), to reduce service interruption due to frequency switching during transmissions. In MBSFN, single frequency is used by multiple cells to perform synchronized transmission at the same time, so as to save frequency resources and enhance spectrum utilization.

In eMBMS, only two logical channels are defined to support point-to-multipoint (p-t-m) downlink transmission: Multicast Control Channel (MCCH) and Multicast Traffic Channel (MTCH). MCCH is utilized for transmitting control messages of all MBMS services in an MBSFN, and MTCH is utilized for transmitting session data of an MBMS service. Both MCCH and MTCH are mapped to a transmission channel newly defined by eMBMS, i.e. Multicast Channel (MCH).

For the current specifications, 3GPP change request R2-093533 is a stage 2 update for the MBMS functionalities. The following description about multi-cell transmission is quoted from this document:

(1) Synchronous transmission of MBMS is performed within an MBSFN Area.

(2) Combining of MBMS transmission from multiple cells is supported.

(3) A single transmission is used for MCH (i.e. neither blind HARQ repetitions nor RLC quick repeat);

(4) A single Transport Block is used per TTI for MCH transmission, and the TB uses all the MBSFN resources in the sub-frame.

(5) MTCH and MCCH can be multiplexed on the same MCH and are mapped on MCH for p-t-m transmission.

In addition, an MCH may simultaneously provides multiple MBMS services, i.e. multiple MBMS services can be mapped to the same MCH, but data transmitted on one MCH should belong to only one MBSFN Area. In other words, an MBSFN area can simultaneously support multiple MBMS services, but since different MBMS services may have different requirements, such as Quality of Service (QoS), Block Error Rate (BLER), according to different characteristics, an MBSFN area may have multiple MCHs. Different MCHs suffice requirements of different MBMS services by applying different modulation and encoding schemes. MCCH is mainly responsible for providing these MCHs with the following control parameters:

(1) Modulation and Coding Scheme (MCS): illustrating encoding and modulation scheme of each MCH.

(2) MBMS service list: listing MBMS services currently provided by each MCH, and including MBMS service ID and session ID, and further including corresponding Logical channel ID (LCID) of MBMS services. Noticeably, MBMS service list only provides session information of MBMS services currently processed. In other words, once a session of one of the MBMS services is ended, a network terminal removes session information of the MBMS service from the MBMS service list, to notify a UE related to the MBMS service that the MBMS service session has been ended.

(3) MCH Sub-frame Allocation Pattern (MSAP): defining a pattern of sub-frames used by each MCH in a scheduling period. A set of these sub-frames used by one MCH is called an MSAP occasion. In each MSAP occasion, a network terminal can apply multiplexing of MTCHs and MCCH corresponding to different MBMS services to be transmitted on the MCH. A transmission order of MTCHs can be determined according to an order of the MBMS service list.

Currently, it is still open whether overlapping MBSFN areas will be supported in Rel-9, i.e. whether a cell can be covered with multiple MBSFN areas. If overlapping MBSFN areas is supported, there will be one MCCH for each MBSFN area. Then, a UE will need to read all MCCHs to know if an MBMS service is available now since the UE cannot know which MBSFN area(s) the MBMS service is broadcast in. In this case, even though the MBMS service is only broadcast in one of the MBSFN areas, the UE still needs to monitor all MCCHs, which causes unnecessary UE power consumption.

### SUMMARY OF THE INVENTION

It is therefore an objective of the present invention to provide a method and apparatus for improving MCCH monitoring mechanism.

The present invention discloses a method for improving MCCH monitoring mechanism in a network terminal of a wireless communication system. The method includes steps of delivering a Multimedia Broadcast Multicast Service (MBMS) service announcement to a user equipment (UE) of the wireless communication system, the MBMS service announcement containing a list of MBMS services provided by the network terminal and service related information of each MBMS service, one of the service related information indicating which MBMS Single Frequency Network (MBSFN) area(s) an MBMS service is broadcast in; transmitting session start information of an MBMS service on the MCCH associated with the indicated MBSFN area(s); and starting broadcasting the MBMS service in the indicated MBSFN area(s).

The present invention further discloses a communication device for improving MCCH monitoring mechanism in a network terminal of a wireless communication system. The communication device includes a processor, for executing a program, and a memory, coupled to the processor, for storing the program. The program includes steps of delivering a Multimedia Broadcast Multicast Service (MBMS) service announcement to a user equipment (UE) of the wireless communication system, the MBMS service announcement containing a list of MBMS services provided by the network terminal and service related information of each MBMS service, one of the service related information indicating which MBMS Single Frequency Network (MBSFN) area(s) an MBMS service is broadcast in; transmitting session start information of an MBMS service on the MCCH associated with the indicated MBSFN area(s); and starting broadcasting the MBMS service in the indicated MBSFN area(s).

The present invention discloses a method for improving MCCH monitoring mechanism in an user equipment (UE) of a wireless communication system. The method includes steps of receiving a Multimedia Broadcast Multicast Service (MBMS) service announcement, the MBMS service announcement containing a list of MBMS services provided by a network terminal of the wireless communication system and service related information of each MBMS service, one of the service related information indicating which MBMS Single Frequency Network (MBSFN) area(s) an MBMS service is broadcast in; monitoring the MCCH associated with the indicated MBSFN area(s) where an UE interested MBMS service is broadcast to determine whether this MBMS service is available; and receiving the UE interested MBMS service in the indicated MBSFN area(s) when this MBMS service is determined available.

The present invention further discloses a communication device for improving MCCH monitoring mechanism in an user equipment (UE) of a wireless communication system. The communication device includes a processor, for executing a program, and a memory, coupled to the processor, for storing the program. The program includes steps of receiving a Multimedia Broadcast Multicast Service (MBMS) service announcement, the MBMS service announcement containing a list of MBMS services provided by a network terminal of the wireless communication system and service related information of each MBMS service, one of the service related information indicating which MBMS Single Frequency Network (MBSFN) area(s) an MBMS service is broadcast in; monitoring the MCCH associated with the indicated MBSFN area(s) where an UE interested MBMS service is broadcast to determine whether this MBMS service is available; and receiving the UE interested MBMS service in the indicated MBSFN area(s) when this MBMS service is determined available.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a schematic diagram of a program code of FIG. 2.

FIG. 4 is a schematic diagram of a process according to an embodiment of the present invention.

FIG. 5 is a schematic diagram of a process according to another embodiment of the present invention.

### DETAILED DESCRIPTION

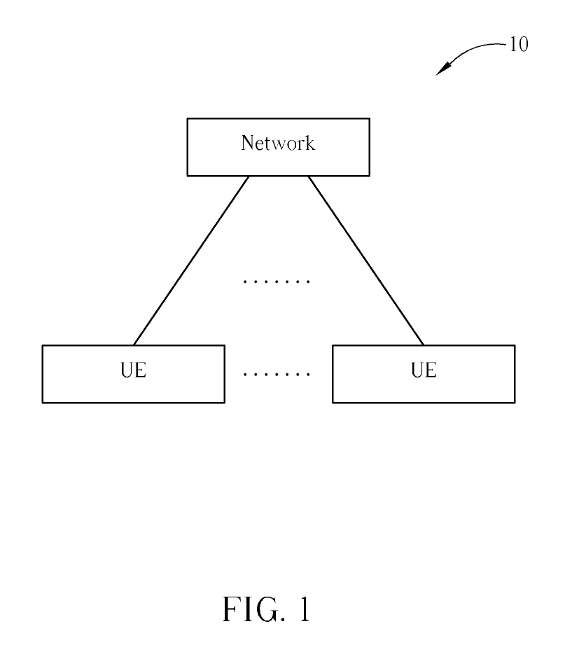

Please refer to FIG. 1, which illustrates a schematic diagram of a wireless communications system 10. The wireless communications system 10 is preferred to be an LTE-advanced (LTE-A) system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

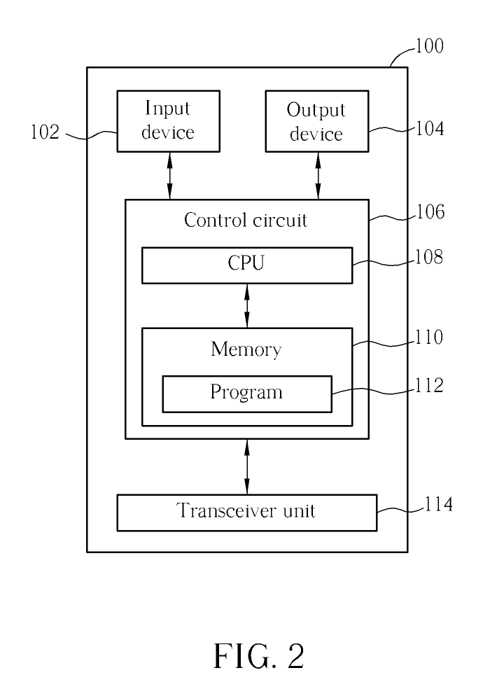

Please refer to FIG. 2, which is a functional block diagram of a communications device 100 in a wireless communications system. The communications device 100 can be utilized for realizing the UEs or the network in FIG. 1. For the sake of brevity, FIG. 2 only shows an input device 102, an output device 104, a control circuit 106, a central processing unit (CPU) 108, a memory 110, a program 112, and a transceiver unit 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver unit 114 is used to receive and transmit wireless signals, delivering received signals to the control circuit 106, and outputting signals generated by the control circuit 106 wirelessly. From a perspective of a communications protocol framework, the transceiver unit 114 can be seen as a portion of Layer 1, and the control circuit 106 can be utilized to realize functions of Layer 2 and Layer 3.

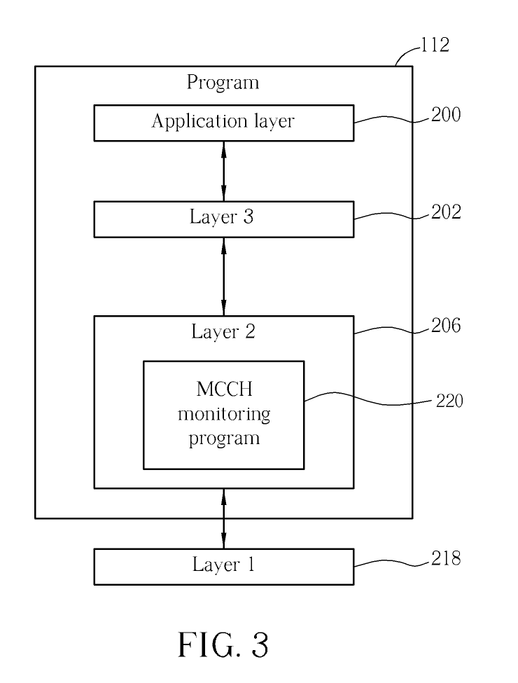

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

The wireless communication system 10 can provide an enhanced MBMS (eMBMS), to support high quality streaming multimedia and real-time multicast and broadcast services. In eMBMS, each MBMS Single Frequency Network (MBSFN) has its corresponding MCCH. Thus, if the wireless communication system supports overlapping MBSFN areas, since a UE cannot know which MBSFN area(s) the MBMS service is broadcast in, the UE needs to monitor session start information on all MCCHs to know whether the MBMS service in available now. In this case, even though the MBMS service is only broadcast in one of the MBSFN areas, the UE still needs to monitor all MCCHs, which causes unnecessary UE power consumption.

Under such a situation, the present invention provides a MCCH monitoring program 220 in the program 112, for solving the problem that the UE needs to monitor all MCCHs when overlapping MBSFN areas is supported, so as to save UE power consumption.

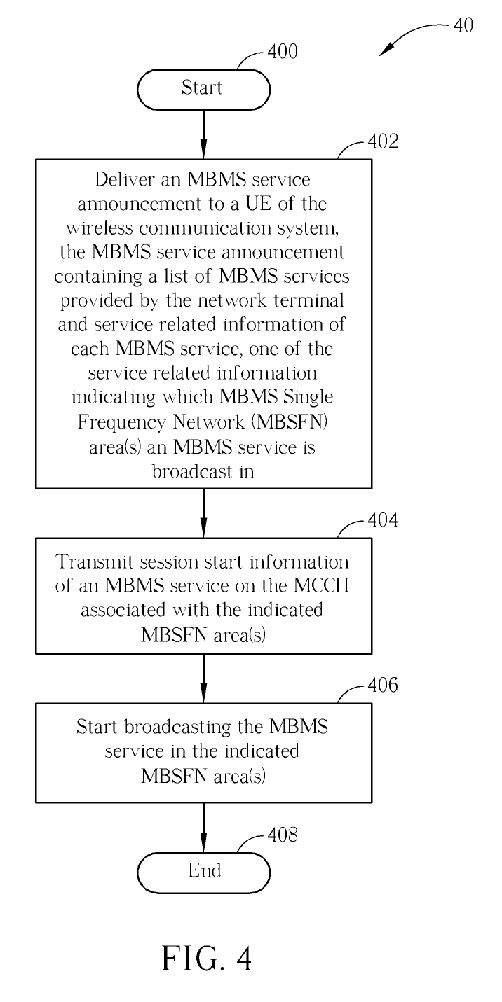

Please refer to FIG. 4, which is a schematic diagram of a process 40 according to an embodiment of the present invention. The process 40 is utilized for improving MCCH monitoring mechanism in a network terminal of a wireless communication system, and can be compiled into the MCCH monitoring program 220. The process 40 includes the following steps:

Step 400: Start.

Step 402: Deliver an MBMS service announcement to a UE of the wireless communication system, the MBMS service announcement containing a list of MBMS services provided by the network terminal and service related information of each MBMS service, one of the service related information indicating which MBMS Single Frequency Network (MBSFN) area(s) an MBMS service is broadcast in.

Step 404: Transmit session start information of an MBMS service on the MCCH associated with the indicated MBSFN area(s).

Step 406: Start broadcasting the MBMS service in the indicated MBSFN area(s).

Step 408: End.

According to the process 40, before starting an MBMS service, the network terminal shall first deliver an MBMS service announcement to UEs of the wireless communication system. The MBMS service announcement contains a list of MBMS services provided by the network terminal and service related information of each MBMS service. The service related information not only includes parameters required for UE to activate an MBMS service (e.g. IP multicast address(es)) and service start time of the MBMS service, but also includes information for indicating which MBMS Single Frequency Network (MBSFN) area(s) the MBMS service is broadcast in. Accordingly, the UE can activate an MBMS service from the list by performing a join session procedure or selecting the service for reception.

Based on the service announcement, the UE only needs to monitor the MCCH associated with the indicated MBSFN area(s) where the UE interested service is broadcast, to know when to start reception of the MBMS service and the required parameters for receiving the MBMS service, such as Modulation and Coding Scheme (MCS). Therefore, the UE need not to monitor all the MCCHs, and thus power consumption can be saved.

In the embodiment of the present invention, the service announcement can be sent to the UE by any kinds of methods, for example but is not limited to, through higher layer messages, via service announcement mechanism or by system broadcast information.

In short, by indicating the MBSFN area (s) where an MBMS service is broadcast, the UE only needs to monitor the MCCH associated with the indicated MBSFN area(s) where the UE interested service is broadcast, so as to save power consumption. Please note that the above mechanism not only can be applied to overlapping MBSFN area, but also can be applied to non-overlapping MBSFN area. For example, by this mechanism, the UE can know whether the MBSFN area which the UE is currently in provides an UE interested MBMS service or not. If the current MBSFN area does not provide the UE interested MBMS service, the UE need not to monitor the MCCH in this area.

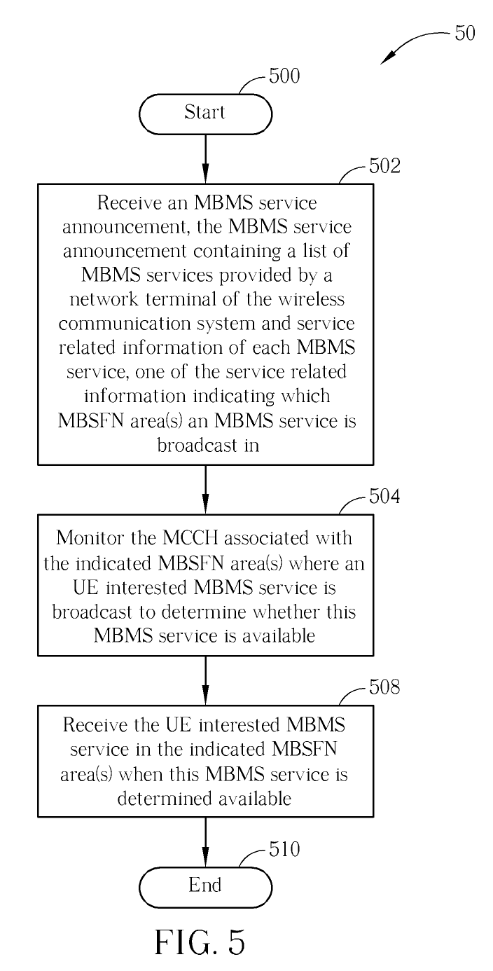

On the other hand, the embodiment of the present invention also provides related operations for the UE to improve the MCCH monitoring mechanism, in order to have the behaviors between the network and the UE be coordinated. Please refer to FIG. 5, which is a schematic diagram of a process 50 according to an embodiment of the present invention. The process 50 is utilized for improving MCCH monitoring mechanism in a UE of a wireless communication system, and can be compiled into the MCCH monitoring program 220 as well. The process 50 includes the following steps:

Step 500: Start.

Step 502: Receive an MBMS service announcement, the MBMS service announcement containing a list of MBMS services provided by a network terminal of the wireless communication system and service related information of each MBMS service, one of the service related information indicating which MBSFN area(s) an MBMS service is broadcast in.

Step 504: Monitor the MCCH associated with the indicated MBSFN area (s) where an UE interested MBMS service is broadcast to determine whether this MBMS service is available.

Step 506: Receive the UE interested MBMS service in the indicated MBSFN area(s) when this MBMS service is determined available.

Step 508: End.

According to the process 50, before starting reception of an MBMS service, the UE receives an MBMS service announcement from the network. The MBMS service announcement contains a list of MBMS services provided by the network and service related information of each MBMS service. The service related information not only includes parameters required for UE to activate an MBMS service (e.g. IP multicast address(es)) and service start time of the MBMS service, but also includes information for indicating which MBMS Single Frequency Network (MBSFN) area(s) the MBMS service is broadcast in. Based on the service announcement, the UE only needs to monitor the MCCH associated with the indicated MBSFN area(s) where an UE interested service is broadcast, to know when to start reception of the MBMS service and the required parameters for receiving the MBMS service. Therefore, the UE need not to monitor all the MCCHs, and thus power consumption can be saved.

In short, by indicating the MBSFN area (s) where an MBMS services is broadcast, the UE only needs to monitor the MCCH associated with the indicated MBSFN area(s) where an UE interested service is broadcast, so as to save power consumption.

To sum up, the embodiment of the present invention provides the method for improving MCCH monitoring mechanism to solve the problem that the UE needs to monitor all the MCCHs no matter overlapping MBSFN areas is supported or not, so as to save UE power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for improving Multicast Control Channel (MCCH) monitoring mechanism in a network terminal of a wireless communication system, the method comprising:
delivering a Multimedia Broadcast Multicast Service (MBMS) service announcement to a user equipment (UE) of the wireless communication system, the MBMS service announcement containing a list of MBMS services provided by the network terminal and service related information of each MBMS service, one of the service related information indicating which MBMS Single Frequency Network (MBSFN) area(s) an MBMS service is broadcast in;
transmitting session start information of an MBMS service on the MCCH associated with the indicated MBSFN area(s); and
starting broadcasting the MBMS service in the indicated MBSFN area(s).

2. The method of claim 1, wherein the service related information of the MBMS service further comprises parameters required for UE to activate the MBMS service and service start time of the MBMS service.

3. The method of claim 1 further comprising:
transmitting parameters required for UE to receive the MBMS service on the MCCH associated with the indicated MBSFN area(s).

4. The method of claim 1, wherein the MBMS service announcement is transmitted to the UE via a service announcement mechanism.

5. The method of claim 1, wherein the MBMS service announcement is transmitted to the UE via system information broadcast.

6. A communication device for improving Multicast Control Channel (MCCH) monitoring mechanism in a network terminal of a wireless communication system, the communication device comprising:
a processor, for executing a program; and
a memory, coupled to the processor, for storing the program, wherein the program comprises:
delivering a Multimedia Broadcast Multicast Service (MBMS) service announcement to a user equipment (UE) of the wireless communication system, the MBMS service announcement containing a list of MBMS services provided by the network terminal and service related information of each MBMS services, one of the service related information indicating which MBMS Single Frequency Network (MBSFN) area(s) an MBMS service is broadcast in;
transmitting session start information of an MBMS service on the MCCH associated with the indicated MBSFN area(s); and
starting broadcasting the MBMS service in the indicated MBSFN area(s).

7. The communication device of claim 6, wherein the service related information of the MBMS service further comprises parameters required for UE to activate the MBMS service and service start time of the MBMS service.

8. The communication device of claim 6, wherein the program further comprises:
transmitting parameters required for UE to receive the MBMS service on the MCCH associated with the indicated MBSFN area(s).

9. The communication device of claim 6, wherein the MBMS service announcement is transmitted to the UE via a service announcement mechanism.

10. The communication device of claim 6, wherein the MBMS service announcement is transmitted to the UE via system information broadcast.

11. A method for improving Multicast Control Channel (MCCH) monitoring mechanism in a user equipment (UE) of a wireless communication system, the method comprising:
receiving a Multimedia Broadcast Multicast Service (MBMS) service announcement, the MBMS service announcement containing a list of MBMS services provided by a network terminal of the wireless communication system and service related information of each MBMS service, one of the service related information indicating which MBMS Single Frequency Network (MBSFN) area(s) an MBMS service is broadcast in;
monitoring the MCCH associated with the indicated MBSFN area(s) where an UE interested MBMS service is broadcast to determine whether this MBMS service is available; and
receiving the UE interested MBMS service in the indicated MBSFN area(s) when this MBMS service is determined available.

12. The method of claim 11, wherein the service related information of the MBMS service further comprises parameters required for UE to activate the MBMS service and service start time of the MBMS service.

13. The method of claim 12, wherein each of the MBMS services is activated when the UE performs a join session procedure.

14. The method of claim 12, wherein each of the MBMS services is activated when the UE selects the MBMS service for reception.

15. The method of claim 11 further comprising:
monitoring the MCCH associated with the indicated MBSFN area(s) where the UE interested MBMS service is broadcast in to acquire parameters for reception of this MBMS service.

16. The method of claim 11, wherein the MBMS service announcement is transmitted to the UE via a service announcement mechanism.

17. The method of claim 11, wherein the MBMS service announcement is transmitted to the UE via system information broadcast.

18. A communication device for improving Multicast Control Channel (MCCH) monitoring mechanism in an user equipment (UE) of a wireless communication system, the communication device comprising:
a processor, for executing a program; and
a memory, coupled to the processor, for storing the program, wherein the program comprises:
receiving a Multimedia Broadcast Multicast Service (MBMS) service announcement, the MBMS service announcement containing a list of MBMS services provided by a network terminal of the wireless communication system and service related information of each MBMS service, one of the service related information indicating which MBMS Single Frequency Network (MBSFN) area(s) an MBMS service is broadcast in;
monitoring the MCCH associated with the indicated MBSFN area (s) where an UE interested MBMS service is broadcast to determine whether this MBMS service is available; and
receiving the UE interested MBMS service in the indicated MBSFN area(s) when this MBMS service is determined available.

19. The communication device of claim 18, wherein the service related information of the MBMS service further comprises parameters required for UE to activate the MBMS service and service start time of the MBMS service.

20. The communication device of claim 19, wherein each of the MBMS services is activated when the UE performs a join session procedure.

21. The communication device of claim 19, wherein each of the MBMS services is activated when the UE selects the MBMS service for reception.

22. The communication device of claim 18 further comprising:
monitoring the MCCH associated with the indicated MBSFN area(s) where the UE interested MBMS service is broadcast in to acquire parameters for reception of this MBMS service.

23. The communication device of claim 18, wherein the MBMS service announcement is transmitted to the UE via a service announcement mechanism.

24. The communication device of claim 18, wherein the MBMS service announcement is transmitted to the UE via system information broadcast.
